(19) United States
(12) Patent Application Publication
(10) Pub. No.: US 2014/0242912 A1
(43) Pub. Date: Aug. 28, 2014

(54) INFORMATION PROCESSING SYSTEM, COMPUTER-READABLE NON-TRANSITORY STORAGE MEDIUM HAVING STORED THEREIN INFORMATION PROCESSING PROGRAM, INFORMATION PROCESSING METHOD, AND INFORMATION PROCESSING APPARATUS

(71) Applicant: NINTENDO CO., LTD., Kyoto (JP)

(72) Inventor: Rina IMAMURA, Kyoto (JP)

(73) Assignee: NINTENDO CO., LTD., Kyoto (JP)

(21) Appl. No.: 14/010,974

(22) Filed: Aug. 27, 2013

(30) Foreign Application Priority Data
Feb. 25, 2013 (JP) 2013-034627

(51) Int. Cl. H04B 7/26

(52) U.S. Cl. CPC H04B 7/26
USPC 455/41.2

(57) ABSTRACT

Predetermined data is transmitted from a first information processing apparatus to an unspecified number of or a plurality of other information processing apparatuses. A second information processing apparatus is capable of detecting a motion applied to the second information processing apparatus itself. When application of the predetermined motion is detected, the second information processing apparatus executes a response process to the predetermined data received from the first information processing apparatus. Thereafter, predetermined processing such as a process for establishing wireless connection is executed between the first information processing apparatus and the second information processing apparatus.

### CROSS REFERENCE TO RELATED APPLICATION

The disclosure of Japanese Patent Application No. 2013-34627, filed on Feb. 25, 2013, is incorporated herein by reference.

### FIELD

The exemplary embodiments disclosed herein relate to an information processing system, a computer-readable non-transitory storage medium having stored therein an information processing program, an information processing method, and an information processing apparatus, for performing wireless communication between a plurality of information processing apparatuses, and more particularly relate to an information processing system, a computer-readable non-transitory storage medium having stored therein an information processing program, an information processing method, and an information processing apparatus, for performing grouping of a plurality of information processing apparatuses which perform communication with each other.

### BACKGROUND AND SUMMARY

Hitherto, game apparatuses are known which perform short-range wireless communication with each other and advance a game. When such communication is performed, for example, when a certain communication game is played, a group of game apparatuses with which the communication game is played is formed from among a plurality of game apparatuses.

In each of such game apparatuses, in forming a group, the player performs a group formation operation by performing a predetermined button operation, a touch operation on a touch panel, or the like while viewing a screen. For example, it is necessary to perform an operation of selecting player(s) for forming a group from other player names displayed on the screen when viewing the other player names, an operation of selecting a group in which the player desires to participate, an operation of issuing a request that the player desires to participate in the game, an operation of responding to the request, or the like. Thus, an operation for forming a group is complicated.

Therefore, it is a feature of the exemplary embodiments to provide an information processing system, an information processing apparatus, a computer-readable non-transitory storage medium having stored therein an information processing program, and an information processing method which allow for group formation with a simple operation when a group of information processing apparatuses which perform wireless communication is formed.

In order to attain the feature described above, the following configuration examples are exemplified.

A configuration example is an information processing system in which a plurality of information processing apparatuses each including a communicator capable of performing short-range wireless communication directly perform transmission/reception of data with each other via the short-range wireless communication. The information processing system includes a first information processing apparatus and a second information processing apparatus. The first information processing apparatus includes: a transmitter configured to transmit predetermined data to an unspecified number of or a plurality of the other information processing apparatuses by using the communicator; and a first process executor configured to execute predetermined information processing. The second information processing apparatus includes: a receiver capable of receiving the predetermined data transmitted from the transmitter, by using the communicator; a motion detector configured to detect a motion applied to the second information processing apparatus; a second process executor configured to execute predetermined information processing; and a response process section configured to execute a response process to the predetermined data received from the first information processing apparatus when application of a predetermined motion to the second information processing apparatus is detected by the motion detector, Each of the first process executor and the second process executor executes the predetermined information processing with the other process executor after the response process is completed.

According to the above configuration example, for example, when a simple operation of “shaking” the information processing apparatus is merely performed, it is possible to make wireless connection with another information processing apparatus.

In another configuration example, the first information processing apparatus may further include the motion detector, and the transmitter may transmit the predetermined data when application of the predetermined motion to the first information processing apparatus is detected by the motion detector of the first information processing apparatus. In addition, the predetermined information processing executed between the first process executor and the second process executor may be a process for establishing connection of the short-range wireless communication.

According to the above configuration example, it is possible to establish wireless connection between the information processing apparatuses to each of which the predetermined motion is being applied. In addition, for example, when a simple operation of “shaking” the information processing apparatus is performed, it is possible to make wireless connection. Thus, it is possible to simplify a user interface for the wireless connection.

In another configuration example, the first information processing apparatus may further include the motion detector. In the information processing system, when the predetermined motion is being detected in both the first information processing apparatus and the second information processing apparatus, a process for establishing connection of the short-range wireless communication may be executed between the first process executor and the second process executor. In addition, the motion detector may detect, as the predetermined motion, a motion of a player shaking the information processing apparatus. Moreover, if the predetermined motion is being detected when the receiver receives the predetermined data transmitted from the transmitter, the response process section may execute the response process to the predetermined data.

According to the above configuration example, for example, when each player shakes the information processing apparatus, the information processing apparatuses that are being shaken at the same timing are wirelessly connected to each other. Thus, with a simple operation, it is possible to indicate intention to connect and establish wireless connection. In addition, it becomes easy to recognize who is a connection partner, and it is possible to smooth communication between the players.

In another configuration example, the information processing system may further include a third information processing apparatus capable of executing the same function as that of the first information processing apparatus, and the predetermined information processing may be executed among the first information processing apparatus, the second information processing apparatus, and the third information processing apparatus. In addition, the information processing system may further include a fourth information processing apparatus capable of executing the same function as that of the second information processing apparatus, and the predetermined information processing may be executed among the first information processing apparatus, the second information processing apparatus, and the fourth information processing apparatus.

According to the above configuration example, for example, when there are three or more players, with a simple operation, it is possible to group players who desire to play a communication game together and cause the players to play together.

In another configuration example, when application of the predetermined motion to the second information processing apparatus is detected by the motion detector, the response process section may continue to execute the response process to the predetermined data for a predetermined period of time, regardless of presence/absence of later detection of the predetermined motion, or when the predetermined motion applied to the second information processing apparatus meets a predetermined condition, the response process section may repeatedly execute the response process to the predetermined data, regardless of presence/absence of later detection of the predetermined motion.

According to the above configuration example, the player does not have to continue the predetermined motion until connection to another information processing apparatus is established, and it is possible to enhance player's convenience.

In another configuration example, the first information processing apparatus may further include the motion detector, the transmitter may transmit data for scanning another information processing apparatus when application of the predetermined motion to the first information processing apparatus is detected by the motion detector of the first information processing apparatus, and the response process section may respond to the scanning when application of the predetermined motion is detected by the motion detector of the second information processing apparatus. Or the transmitter may transmit, to another information processing apparatus, data representing a connection request when application of the predetermined motion to the first information processing apparatus is detected by the motion detector of the first information processing apparatus, and the response process section may respond to the connection request when application of the predetermined motion is detected by the motion detector of the second information processing apparatus.

According to the above configuration example, for example, when a simple operation of “shaking” the information processing apparatus is merely performed, it is possible to establish wireless connection to another information processing apparatus.

In another configuration example, the information processing system may further include a fifth information processing apparatus capable of executing the same function as that of the first information processing apparatus. The second information processing apparatus may further include a notifier configured to execute a process for prompting a player of the second information processing apparatus to make the predetermined motion. The receiver may continue a process of receiving the predetermined data even after predetermined processing is started between the first process executor and the second process executor, and the notifier may execute the process for prompting to make the predetermined motion when the receiver receives the predetermined data from the fifth information processing apparatus after the predetermined processing is started between the first process executor and the second process executor. In the information processing system, when the predetermined motion is detected, the predetermined information processing may be executed among the first information processing apparatus, the second information processing apparatus, and the fifth information processing apparatus.

According to the above configuration example, for example, even after a communication game is started between two information processing apparatuses, another player is allowed to participate in the communication game that has been started.

Another configuration example is an information processing apparatus including a communicator capable of performing short-range wireless communication. The information processing apparatus includes: a motion detector configured to detect a motion applied to the information processing apparatus; and a scanning process executor configured to perform a process of scanning another information processing apparatus when application of a predetermined motion to the information processing apparatus is detected by the motion detector.

According to the above configuration example, for example, when the player merely performs an operation of “shaking” the information processing apparatus, it is possible to scan another information processing apparatus to which wireless connection is possible.

Another configuration example is an information processing apparatus including a communicator capable of performing short-range wireless communication. The information processing apparatus includes: a motion detector configured to detect a motion applied to the information processing apparatus; and a response process section configured to execute a process of responding to a scanning process performed by another information processing apparatus when application of a predetermined motion to the information processing apparatus is detected by the motion detector.

According to the above configuration example, for example, when the player merely performs an operation of “shaking” the information processing apparatus, it is possible to respond to a scanning process performed in another information processing apparatus and to establish wireless connection.

Another configuration example is an information processing apparatus including a communicator capable of performing short-range wireless communication. The information processing apparatus includes: a motion detector configured to detect a motion applied to the information processing apparatus; and a connection requester configured to execute a connection request process of requesting wireless connection to an unspecified number of or a plurality of other information processing apparatuses when application of a predetermined motion to the information processing apparatus is detected by the motion detector.

According to the above configuration example, for example, when the player merely performs an operation of “shaking” the information processing apparatus, it is possible to send a connection request to another information processing apparatus.

Another configuration example is an information processing apparatus including a communicator capable of performing short-range wireless communication. The information processing apparatus includes: a motion detector configured to detect a motion applied to the information processing apparatus; and a connection responder configured to execute a process of responding to a connection request from another information processing apparatus when application of a predetermined motion to the information processing apparatus is detected by the motion detector.

According to the above configuration example, for example, when the player merely performs an operation of “shaking” the information processing apparatus, it is possible to respond to a connection request from another information processing apparatus.

According to the present embodiment, with a simple operation, it is possible to establish wireless connection between the information processing apparatuses of players who desire connection to each other and it is possible to easily form a group for performing communication with each other.

### BRIEF DESCRIPTION OF THE DRAWINGS

FIG. 1 is a schematic diagram showing the whole image of an information processing system which is a non-limiting example of an embodiment;

FIG. 2 is a block diagram showing a non-limiting example of the configuration of a handheld game apparatus 10;

FIG. 3 is a diagram showing a non-limiting example of group formation;

FIG. 4 is a schematic diagram showing flow to start of a communication game in the embodiment;

FIG. 5 is a non-limiting example of a program and information stored in a main memory 15 of the handheld game apparatus 10;

FIG. 6 is a flowchart showing in detail a process when the handheld game apparatus 10 becomes a master apparatus; and

FIG. 7 is a flowchart showing in detail a process when the handheld game apparatus 10 becomes a slave apparatus.

### DETAILED DESCRIPTION OF NON-LIMITING EXAMPLE EMBODIMENTS

Hereinafter, one exemplary embodiment of the present invention will be described.

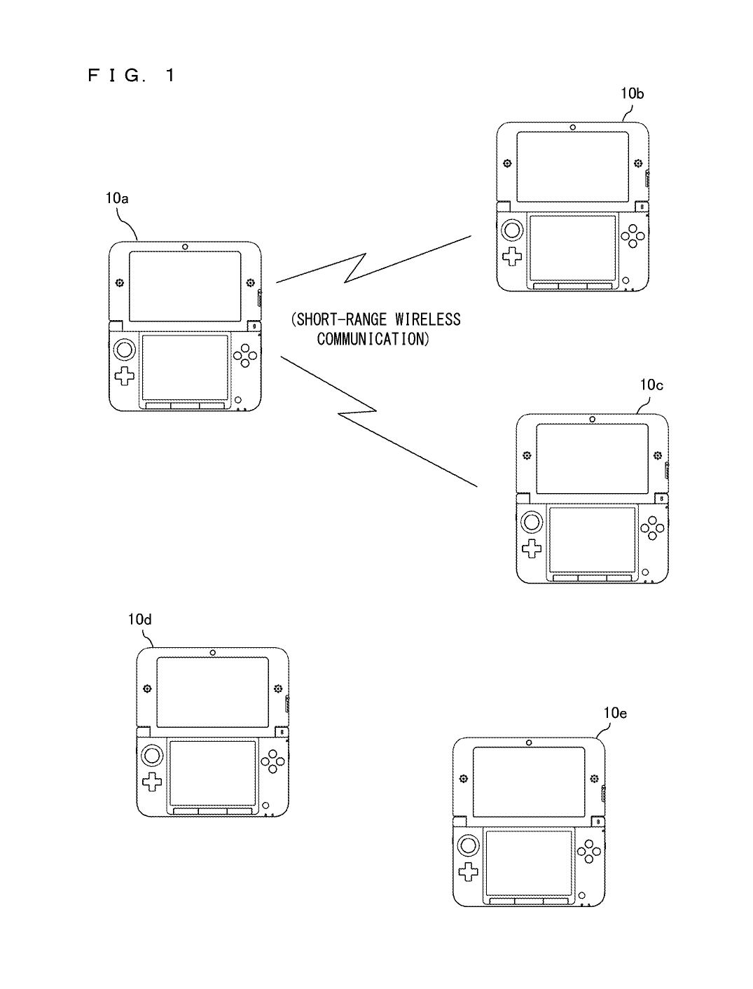

FIG. 1 is a schematic diagram showing the whole image of an information processing system which is an example of the present embodiment. In FIG. 1, handheld game apparatuses 10a to 10e (hereinafter, sometimes collectively referred to as handheld game apparatus 10) which are examples of information processing apparatuses are shown. Each handheld game apparatus 10 has a wireless communication function, and the handheld game apparatuses 10 are capable of wirelessly connecting directly to each other (not via any access point and the Internet) to perform wireless communication with each other. The example of FIG. 1 shows a state where, of the five handheld game apparatuses 10, the handheld game apparatuses 10a and 10b are wirelessly connected to each other and the handheld game apparatuses 10a and 10c are wirelessly connected to each other. In other words, it is in a state where one group is formed of these three apparatuses, and a predetermined communication game or the like is executed among these three apparatuses.

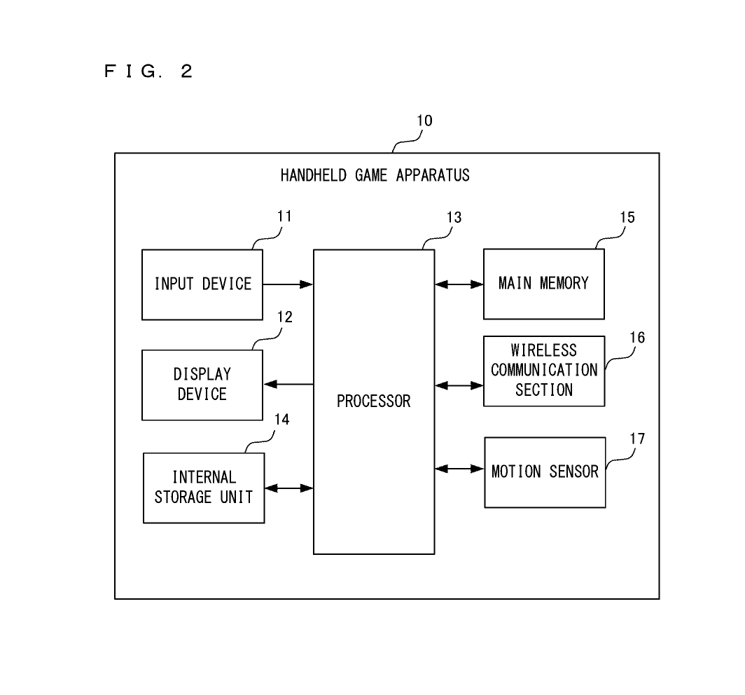

FIG. 2 is a function block diagram of the handheld game apparatus 10. In FIG. 2, the handheld game apparatus 10 includes an input device 11, a display device 12, a processor 13, an internal storage unit 14, a main memory 15, a wireless communication section 16, and a motion sensor 17.

The input device 11 is operated by the user of the handheld game apparatus 10 and outputs a signal corresponding to the operation of the user. The input device 11 is, for example, a cross switch, a push button, or a touch panel. The display device 12 displays, on a screen, an image generated in the handheld game apparatus 10. The display device 12 is typically a liquid crystal display device. In the internal storage unit 14, computer programs to be executed by the processor 13 and various data to be used in the programs are stored. The internal storage unit 14 is typically a flash EEPROM. The main memory 15 temporarily stores a computer program and information. The wireless communication section 16 transmits a signal to another handheld game apparatus via wireless communication and receives a signal from another handheld game apparatus via wireless communication. The motion sensor 17 is a sensor for detecting a motion of the handheld game apparatus 10. In the present embodiment, as an example, the motion sensor 17 includes an acceleration sensor and an angular velocity sensor. The acceleration sensor detects magnitudes of accelerations (linear accelerations) in the directions of straight lines along three axial (xyz axial) directions, respectively. In addition, the angular velocity sensor detects angular velocities about the three axes (xyz axes).

It is noted that other than the acceleration sensor and the angular velocity sensor, the motion sensor 17 may be another motion sensor such as a velocity sensor, a displacement sensor, or a rotation angle sensor, or a magnetic sensor or an image sensor may be used. The motion sensor 17 may be any sensor as long as the sensor is capable of detecting a motion of the handheld game apparatus 10.

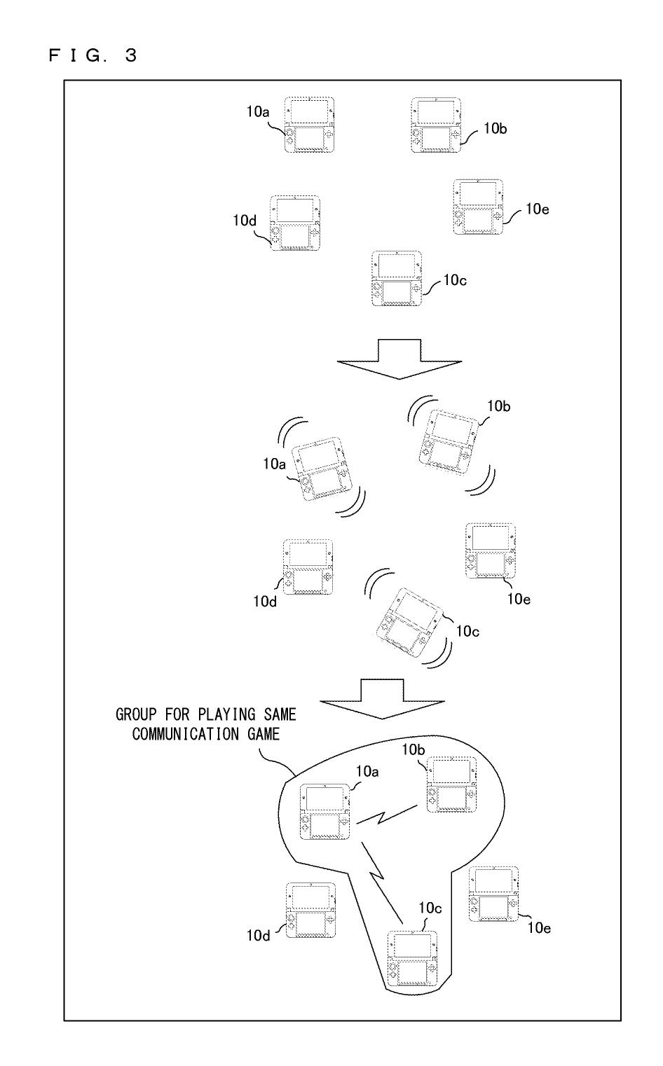

Next, an outline of operation of information processing performed in the information processing system according to the present embodiment (information processing performed by each handheld game apparatus 10) will be described. The processing according to the present embodiment is, for example, processing of performing establishment of wireless connection (and group formation associated therewith) when a communication game or the like is performed between the handheld game apparatuses 10. The present embodiment can be used for, for example, a case of inviting participants for a versus game such as a racing game. In addition, the present embodiment can be used for, for example, a case of inviting a character of another player into a virtual village in a virtual world in the self-apparatus (an operation corresponding to opening a gate of the village). Specifically, in the present embodiment, as an indication of intention of each player about participation (connection) in forming a group, the player is caused to perform an operation of applying a predetermined motion to the handheld game apparatus 10. In the present embodiment, as an example of the predetermined motion, the player is caused to perform an operation of “shaking” (as a matter of course, it is needless to say that, in another embodiment, a predetermined motion other than shaking may be performed, and, for example, an operation of moving the handheld game apparatus 10 as if drawing a circle may be performed). A group for playing the communication game is formed between the handheld game apparatuses 10 being shaken. In other words, it is determined that the players who are shaking the handheld game apparatuses 10 reach agreement with each other to play together, and a process for establishing wireless connection, a game process using the wireless communication after the establishment of the connection, and the like are performed. For example, as shown in FIG. 3, in the case where there are five handheld game apparatuses 10, when the handheld game apparatuses 10a, 10b, and 10c are simultaneously shaken, wireless communication is established among these three apparatuses, and a group for playing a communication game is formed.

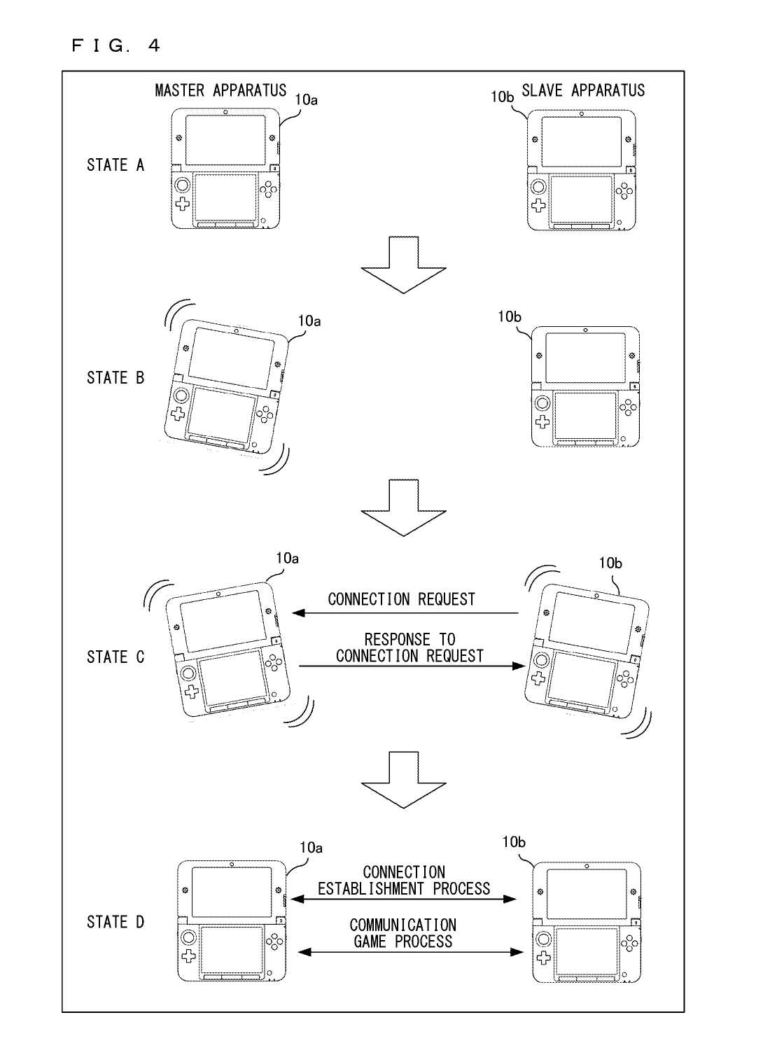

FIG. 4 is a schematic diagram showing flow to start of a communication game in the present embodiment. FIG. 4 shows, as an example, flow until the two handheld game apparatuses 10a and 10b are wirelessly connected to each other and the communication game is started, and the flow is shown with four states A to D.

First, the state A indicates a state prior to start of the communication game (a state where it is desired to start the communication game now). In this state, the player of each game apparatus 10 performs an operation for starting the communication game. For example, each player performs an operation of selecting “Communication Play” from a menu screen. In accordance with this operation, a preparation process for starting a process described below is performed as appropriate in each handheld game apparatus 10. It is noted that when the preparation process is ended, a message indicating the end of the preparation process may be displayed on the screen of each handheld game apparatus 10 to notify each player of the end of the preparation process.

Next, a process for establishing wireless connection between two game apparatuses is performed. Here, as a method for connection between these game apparatuses, a method of connecting these game apparatuses in the following sequence will be described as an example in the present embodiment. In the present embodiment, a method is used in which scanning of (search for) a connection partner is performed by exchanging probe request/response frames, and if a connection partner is found, a connection establishment process is performed. Specifically, first, a frame called “probe request” is broadcasted from the handheld game apparatus 10b. Hereinafter, this frame is sometimes referred to as “probe request frame” or merely as “connection request”. Next, the handheld game apparatus 10a receives the probe request frame, and, on the basis of information included in this frame, the handheld game apparatus 10a returns a frame called “probe response” to the handheld game apparatus 10b. Hereinafter, this frame is sometimes referred to as “probe response frame” or merely as “connection response”. Thus, the handheld game apparatus 10b that has received the probe response frame is able to obtain information regarding the handheld game apparatus 10a, and then a process (connection establishment process) for establishing wireless connection between these game apparatuses is performed. Then, when the wireless connection is established, a communication game process using this connection is performed as appropriate.

It is noted that hereinafter, for convenience of explanation, the handheld game apparatus 10a is sometimes referred to as “master apparatus”, and the handheld game apparatus 10b is sometimes referred to as “slave apparatus”. In addition, in the present embodiment, the “master apparatus” is considered as an apparatus which invites participants for the communication game, and the “slave apparatus” is considered as an apparatus which participates in the communication game in response to the invitation from the master apparatus.

On the assumption of the connection method described above, the following operations and processes are actually performed. First, in the state B, for example, the player (hereinafter, referred to as player A) of the handheld game apparatus 10a (master apparatus) performs an operation of “shaking” the handheld game apparatus 10a while vocally calling out by saying, for example, “Is there anybody who wants to play together?”. In the handheld game apparatus 10a, this shaking operation is detected, and a process of waiting for the above probe request frame is started in accordance with this detection. In other words, while the handheld game apparatus 10a is shaken, the handheld game apparatus 10a goes into a state where it is possible to receive the probe request frame; and when the handheld game apparatus 10a is not shaken, the handheld game apparatus 10a goes into a state where the probe request frame is not received.

It is noted that in another embodiment, reception of the probe request frame may be always performed. Only when a shaking operation is detected, a process of returning a response frame to the probe request frame may be performed; and when a shaking operation is not detected, the received probe request frame may be neglected or discarded. In other words, if a shaking operation is being detected when the probe request frame is received from the handheld game apparatus 10b (slave apparatus), the process of returning a probe response frame is performed. If a shaking operation is not being detected, even when the probe request frame is received, a probe response frame is not returned.

Next, in the state C, in response to the calling of the player A, the player (hereinafter, referred to as player B) of the handheld game apparatus 10b performs an operation of “shaking” the handheld game apparatus 10b. In the handheld game apparatus 10b, this shaking operation is detected, and a process of transmitting (hereinafter, referred to as a process of broadcasting) the above probe request frame to an unspecified number of or a plurality of other handheld game apparatuses 10 is performed in accordance with this detection. That is, in the handheld game apparatus 10b, the probe request frame can be transmitted when the handheld game apparatus 10b is “shaken”. In other words, unless the handheld game apparatus 10b is shaken, the probe request frame is not broadcasted. Then, the probe request frame is received by the handheld game apparatus 10a on which the shaking operation is being performed. As a result, a state is provided in which partners that desire to communicate with each other are identified.

It is noted that in another embodiment, the slave apparatus may broadcast the above probe request frame regardless of whether a shaking operation is performed, and when a shaking operation is detected, the slave apparatus may incorporate information indicating the detection into the probe request frame and may broadcast the probe request frame. For example, a “shaking operation detection flag” may be incorporated into the probe request frame, and only when a shaking operation is detected, the flag may be set to ON and the probe request frame may be broadcasted. Then, the master apparatus may refer to the flag included in the received probe request frame and may determine whether the slave apparatus is being shaken. When the flag is ON and a shaking operation as described above is detected also in the master apparatus, the master apparatus may return a probe response frame.

Next, as shown in the state D, the connection establishment process is performed between the handheld game apparatuses 10a and 10b. It is noted that at timing when the connection establishment process is started, notice indicating the start of the connection establishment process may be given (e.g., a predetermined sound is emitted). Because of this notice, each player can know timing when the player stops the shaking operation on the own handheld game apparatus 10. Then, when wireless connection is established, the communication game process is started between the handheld game apparatuses 10a and 10b.

As described above, in the present embodiment, only when the handheld game apparatus 10 is being shaken, it is possible to transmit and receive connection request/response frames. Thus, it is possible to establish connection without performing a complicated operation.

It is noted that in the present embodiment, the example using the probe request/response frames as described above is exemplified as an example of the connection method, but the connection method is not limited thereto. For example, in another embodiment, the following method may be used. In the state B in FIG. 4, the master apparatus may broadcast a “beacon” only while being shaken, and in the state C, the slave apparatus may go into a state where it is possible to receive the beacon (namely, may perform a process of scanning/searching for another apparatus), only while being shaken. Then, the slave apparatus may detect the master apparatus as a connection partner on the basis of the beacon, and may proceed to the connection establishment process. In other words, any connection method may be used as long as a process related to connection establishment (a process of scanning/searching for a connection partner and a process of responding to this process, or a process of transmitting a connection request to an unspecified number of or a plurality of other apparatuses and a process of responding to the request, etc.) can be performed only when shaking of the handheld game apparatus 10 is being detected.

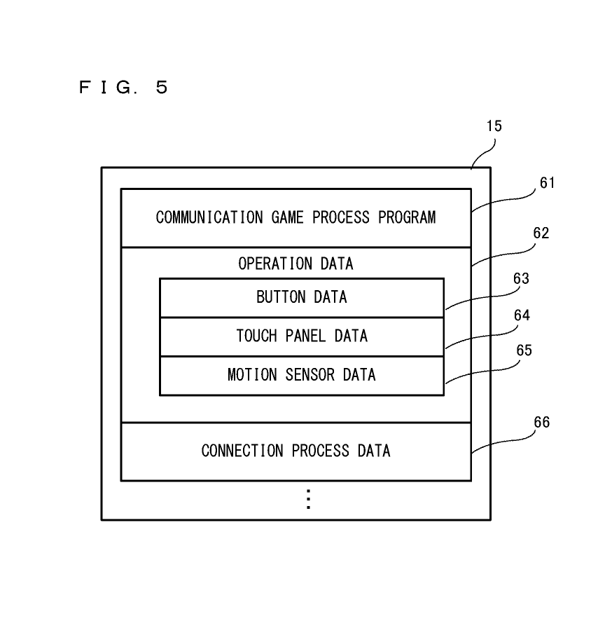

Next, an operation of the handheld game apparatus 10 in the present embodiment will be described in more detail with reference to FIGS. 5 to 7.

FIG. 5 shows an example of a program and information stored in the main memory 15 of the handheld game apparatus 10 (which are common between the case of being a master apparatus and the case of being a slave apparatus). In the main memory 15, a communication game process program 61, operation data 62, and connection process data 66, and the like are stored.

The communication game process program 61 is a program for performing a process for establishing connection of wireless communication as described above with reference to FIG. 4 and for executing a communication game using the established connection.

The operation data 62 is data representing various operations performed on the handheld game apparatus 10. The operation data 62 includes button data 63, touch panel data 64, and motion sensor data 65. The button data 63 and the touch panel data 64 are data representing the contents of operations performed on the input device 11, and are data representing pressed states of various buttons, a touch coordinate of a touch panel, and the like. In addition, the motion sensor data 65 is acceleration data and angular velocity data outputted from the motion sensor 17.

The connection process data 66 is various data used to establish wireless connection, such as data used to create the above-described probe request/response frames.

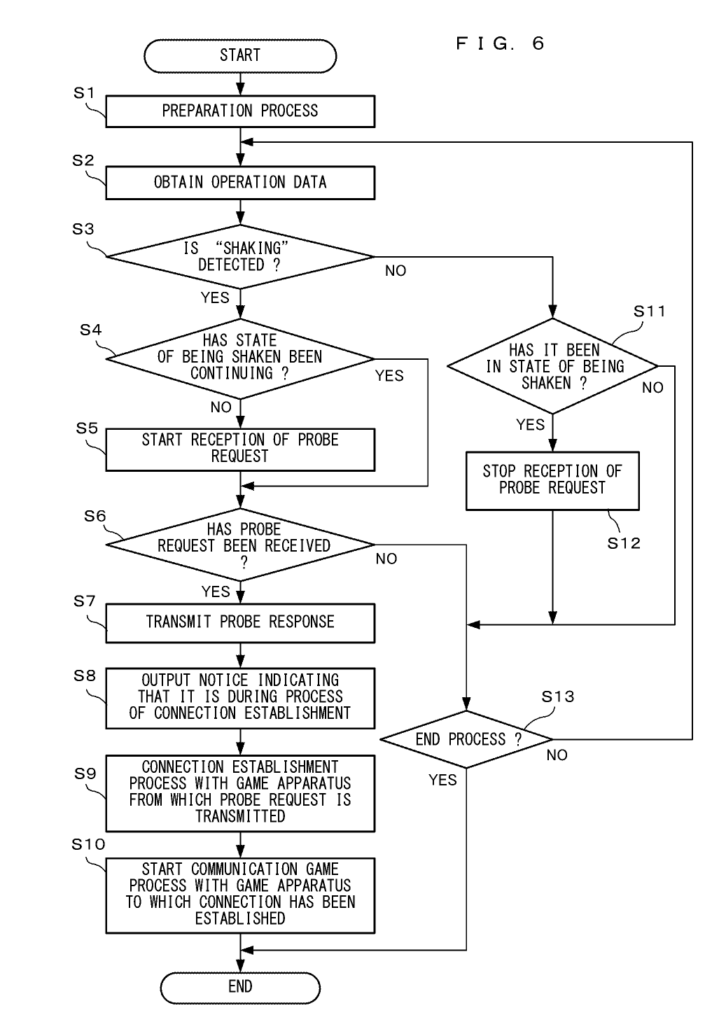

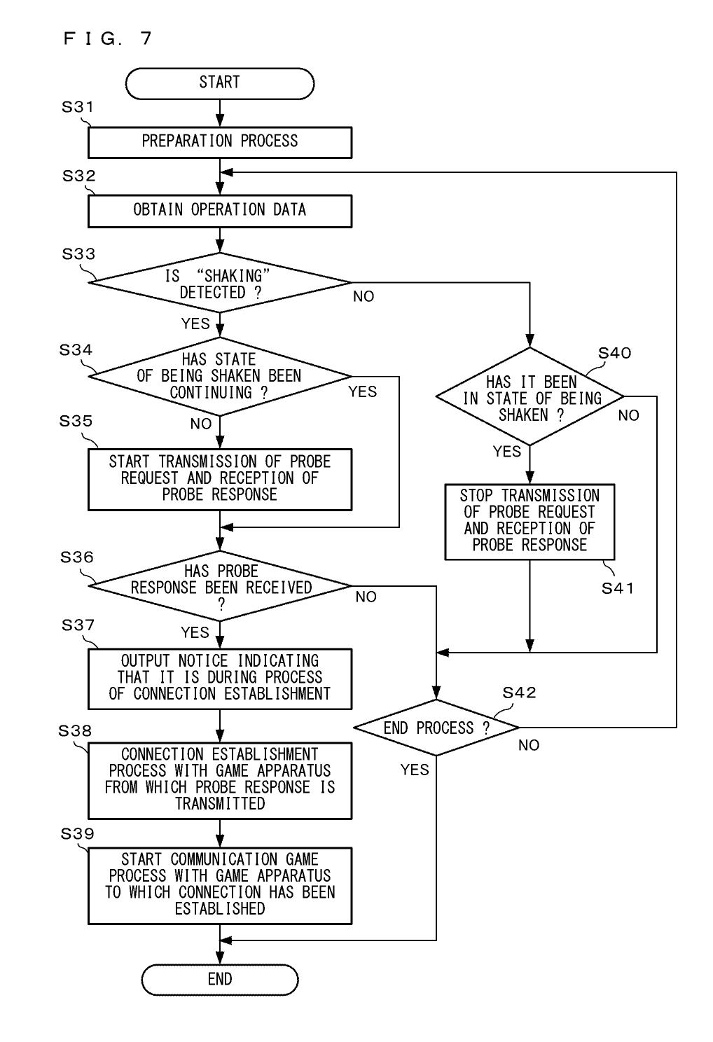

Next, flow of a process performed by the processor 13 of the handheld game apparatus 10 will be described with reference to flowcharts in FIGS. 6 and 7. FIG. 6 shows a process performed when the handheld game apparatus 10 becomes a master apparatus, and FIG. 7 shows a process performed when the handheld game apparatus 10 becomes a slave apparatus.

First, the process performed when the handheld game apparatus 10 becomes a master apparatus will be descried. In FIG. 6, in step 51, the processor 13 performs a preparation process. In this process, initialization of various data to be used in the following processes, and the like are performed. In addition, in this process, setting is also performed regarding whether the handheld game apparatus 10 serves as a master apparatus or a slave apparatus. For example, the player selects “Communication Mode” from an initial menu of a communication game, two options of “Invite” and “Participate” (the former corresponds to the master apparatus, and the latter corresponds to the slave apparatus) are displayed in a menu of the communication mode, and the player is caused to select either option. Then, in accordance with the selection result, setting is performed regarding whether the handheld game apparatus 10 becomes a master apparatus or a slave apparatus. Here, “Invite” is selected, and setting is performed such that the handheld game apparatus 10 serves as a master apparatus.

Next, in step S2, the processor 13 obtains the operation data 62. Next, in step S3, the processor 13 determines whether the self-apparatus (handheld game apparatus 10) is being shaken, on the basis of the motion sensor data 65 (acceleration data, etc.) included in the operation data 62. For the determination as to “being shaken”, namely, a method of detecting a shaking operation, known technology may be used. However, in order to prevent the handheld game apparatus 10 from being determined as “being shaken” contrary to intention of the player (e.g., when the player only slightly moves the handheld game apparatus 10), a predetermined threshold is preferably used or whether a predetermined condition is met is preferably determined for detecting “being shaken”. For example, it is preferred that “being shaken” is determined when a predetermined motion (e.g., reciprocation along a predetermined axis) is detected, when a motion made continuously for a predetermined period of time is detected, or when a predetermined amount or more of a motion (e.g., a motion which is large to some extent) is detected.

As a result of the above determination, when the self-apparatus is being shaken (YES in step S3), the processor 13 determines, in subsequent step S4, whether the state of being shaken has been continuing. In other words, the process 13 determines the shaking has just started or the state of being continuously shaken has been continuing. As a result, when the state of being shaken has not been continuing (NO in step S4), it means that the shaking has just started, and thus the processor 13 starts receiving a probe request frame in step S5 (i.e., starts a process of receiving a probe request frame). On the other hand, when the state of being shaken has been continuing (YES in step S4), it means that the self-apparatus has already gone into a state where it is possible to receive a probe request frame, and thus the process in step S5 is skipped.

Next, in step S6, the processor 13 determines whether a probe request frame has been received. As a result, when a probe request frame has not been received (NO in step S6), the processing proceeds to later-described step S13. On the other hand, when a probe request frame has been received (YES in step S6), the processor 13 refers to information included in the received probe request frame and generates a probe response frame in step S7. Then, the processor 13 transmits the generated probe response frame to the handheld game apparatus 10 that is a transmission source of the received probe request frame.

Next, in step S8, the processor 13 finds a connection partner, and appropriately generates and outputs a notice indicating, for example, that it is during a connection establishment process with the partner. For example, the processor 13 performs a process of displaying a predetermined message on the screen or a process of emitting a predetermined sound.

Next, in step S9, the processor 13 performs a process for establishing wireless connection to the handheld game apparatus 10 that is the transmission source of the probe request frame.

It is noted that regarding the above processes in steps S6 to S9, when probe requests are received from a plurality of slave apparatuses, the connection establishment process is performed for all the slave apparatuses. In addition, in another embodiment, for example, only reception of a probe request and transmission of a probe response may be performed during a period when the master apparatus is being shaken, information on each slave apparatus to which connection should be established may be temporarily stored during the period, and the connection establishment process may be sequentially performed on the basis of the stored information on each slave apparatus at timing when the shaking operation on the master apparatus is stopped. In addition, a method for establishing wireless connection is not limited to the above method, and a publicly-known method other than the above method may be used.

When the wireless connection to the slave apparatus is established, the processor 13 starts, in step S10, a communication game process with the handheld game apparatus 10 to which the connection has been established.

Next, a process performed when, as a result of the above determination in step S3, the self-apparatus is determined as not being shaken (No in step S3), will be described. In this case, in step S11, the processor 13 determines whether, until just before, it has been in a state where the self-apparatus is being shaken. In other words, the process 13 determines whether it is in a state immediately after the operation of shaking the self-apparatus is stopped, or a state where the self-apparatus is not shaken has been continuing. As a result of this determination, when, until just before, it has been in a state where the self-apparatus is being shaken (YES in step S 11), it means that the self-apparatus has gone into a state where it is possible to receive a probe request frame, and thus the processor 13 cancels this state in step S12. In other words, the processor 13 performs a process of stopping receiving a probe request frame. On the other hand, when a state where the self-apparatus is not shaken has been continuing (NO in step S 11), the process in step S12 is skipped.

Next, in step S13, the processor 13 determines whether a condition for ending the process according to this flowchart is met. For example, it is determined whether an operation for cancelling the connection has been performed by the player. As a result, when the condition for ending the process is not met (NO in step S 13), the processor 13 returns to step S2 and the processing is repeated. When the condition for ending the process is met (YES in step S 13), the processor 13 ends the process according to this flowchart.

Next, the process performed when the handheld game apparatus 10 becomes a slave apparatus will be described with reference to FIG. 7. In FIG. 7, in step S31, the processor 13 performs a preparation process. This process is basically the same as the above process in step Si in FIG. 6. As a result of this process, the self-apparatus is set as a slave apparatus.

Next, in step S32, the processor 13 obtains the operation data 62. Next, in step S33, the processor 13 determines whether the self-apparatus is being shaken, on the basis of the motion sensor data 65. As a result of this determination, when the self-apparatus is being shaken (YES in step S33), the processor 13 determines, in step S34, whether the state of being shaken is a continuing state. As a result, when the state of being shaken has not been continuing (NO in step S34), it means that the shaking has just started, and thus the processor 13 starts a process of broadcasting a probe request frame in step S35. In addition, the processor 13 also starts a process of receiving a probe response frame. On the other hand, the state of being shaken has been continuing (YES in step S34), the process in step S35 is skipped.

Next, in step S36, the processor 13 determines whether a probe response frame has been received. As a result, when a probe response frame has not been received (NO in step S36), the processing proceeds to later-described step S42. On the other hand, when a probe response frame has been received (YES in step S36), the processor 13, in step S37, finds a connection partner and appropriately generates and outputs a notice indicating, for example, that it is during a connection establishment process with the partner. For example, the processor 13 performs a process of displaying a predetermined message on the screen or a process of emitting a predetermined sound.

Next, in step S38, on the basis of information included in the received probe response frame, the processor 13 performs a process for establishing wireless connection to the handheld game apparatus 10 that is a transmission source of the probe response frame.

When the wireless connection is established, the processor 13 starts a communication game process with the handheld game apparatus 10 in step S39.

Next, a process performed when, as a result of the above determination in step S33, the self-apparatus is determined as not being shaken (NO in step S33), will be described. In this case, in step S40, the processor 13 determines whether, until just before, it has been in a state where the self-apparatus is being shaken. As a result of this determination, when, until just before, it has been in a state where the self-apparatus is being shaken (YES in step S40), the processor 13 stops, in step S41, the process of broadcasting a probe request frame and the process of receiving a probe response frame. On the other hand, when the state of not being shaken has been continuing (NO in step S40), the process in step S41 is skipped.

Next, in step S42, the processor 13 determines whether a condition for ending the process according to this flowchart is met. When the condition for ending the process is not met (NO step S42), the processor 13 returns to step S32 and the processing is repeated. When the condition for ending the process is met (YES in step S42), the processor 13 ends the process according to this flowchart.

As described above, in the present embodiment, the connection process is enabled only when the handheld game apparatus 10 is being shaken. Thus, it is possible to establish wireless connection between the handheld game apparatuses 10 without performing a complicated operation. As a result, in the case where a plurality of handheld game apparatuses 10 are located near each other, when a group for playing a communication game is formed, it is possible to establish wireless connection between the handheld game apparatuses the players who desire connection to each other without performing a complicated operation such as performing a button operation while viewing the screen, whereby the group can be formed. For example, in a situation where there are five handheld game apparatuses as shown in FIG. 1, it is assumed that only three of these apparatuses, for example, the handheld game apparatuses 10a, 10b, and 10c, execute a communication game. In this case, when the players of the handheld game apparatuses 10a (master apparatus), 10b (slave apparatus 1), and 10c (slave apparatus 2) merely shake the handheld game apparatuses 10 at the same timing (the state corresponds to a state where another one slave apparatus is added in the state C in FIG. 4), a group of these three apparatuses is formed, and the communication game can be executed among these three apparatuses. Thus, for the players, with only a simple operation of shaking the handheld game apparatus 10, wireless connection can be established, and it is possible to start the communication game. Particularly, in the handheld game apparatus that becomes a slave apparatus, it is possible to simplify a user interface for performing an operation for participating in the communication game. In addition, in this case, for example, when each player vocally calls out to each other, the faces and the like of persons who play the communication game together can be directly and visually recognized, and it is possible to smooth communication between the players who play together. Moreover, on the other hand, for a player who does not desire to play the communication game, for example, even when the player A shakes the handheld game apparatus 10a, the player just does not shake the own handheld game apparatus 10, and it also becomes easy to identify a player who desires to play the communication game and a player who does not desire to play the communication game (further grouping becomes easy). Furthermore, when it is visually recognized that the handheld game apparatus 10 that is a master apparatus is being shaken, the player of each slave apparatus can directly recognize which handheld game apparatus is the master apparatus, and when the self-apparatus (slave apparatus) is merely shaken in response to this shaking, the slave apparatus becomes connectable to the master apparatus. Thus, there is an advantage that it is not necessary to previously know identification information such as the apparatus ID of the master apparatus (hitherto, there are some cases where it is impossible to designate a connection partner unless ID of the connection partner is known).

As described above, in the present embodiment, intention to connect is indicated by “shaking” the handheld game apparatus 10, and a process related to establishment of wireless connection (a process of searing for a connection partner and a process of responding thereto, or a process of transmitting a connection request to an unspecified number of or a plurality of other apparatuses and a process of responding to the connecting request) is performed with this shaking operation as a trigger. Such a process is applicable to embodiments described below, in addition to the above-described embodiment.

For example, after the communication game process is started by the process described above, another player may be allowed to participate in the game that has been started. For example, during execution of the communication game process, a player who desires to participate in the game that has been started may shake the own apparatus (which becomes a slave apparatus), and the master apparatus may detect presence of this slave apparatus and may give a notice indicating the detection of the player who desires to participate in the game (e.g., during execution of the communication game, the master apparatus may go into a state where it is possible to receive a probe request frame, regardless of whether a shaking operation is performed). The player of the master apparatus who sees this notice may shake the own apparatus, whereby wireless connection to the slave apparatus of the player who desires to participate in the game that has been started may also be established and the communication game process may be performed including also the slave apparatus of the player who desires to participate in the game that has been started.

In the embodiment described above, the case where exchange of probe request/response frames, and the like are performed while the handheld game apparatuses 10 are shaken, has been exemplified. In addition to this, when a shaking operation is detected, even if the shaking operation is stopped just after, the process of exchanging probe request/response frames as described above, and the like may be performed. For example, when a shaking operation is detected once, exchange of the probe request/response frame as described above, and the like may be performed during a predetermined period of time (e.g., 10 seconds, etc.) after the detection, regardless of whether the self-apparatus is being shaken. In addition, even when a shaking operation is detected once and the shaking operation is stopped thereafter, the above exchange of probe request/response frames and the like may not be stopped immediately, and may be stopped after elapse of a predetermined period of time from stopping of the shaking operation.

The above-described process until establishment of connection may be part of the communication game process, or may be implemented as one function realized by a system program of the handheld game apparatus 10 (i.e., implemented as part of the functions of an OS). When the process is implemented as the system program, for example, a handheld game apparatus in which a game cartridge of the communication game is mounted may become a “master apparatus”, and a game apparatus in which such a game cartridge is not mounted may become a slave apparatus. Then, after a connection establishment process using a shaking operation is performed as described above, a communication game program may be transmitted from the master apparatus to the slave apparatus (downloaded by the slave apparatus from the master apparatus) and then the communication game may be executed.

For example, when there are a plurality of master apparatuses and these apparatuses are simultaneously shaken, as a process in the slave apparatus, for example, a master apparatus from which the slave apparatus receives a probe response frame earliest may be set as a connection partner, or reception of a probe response frame may be performed for a predetermined period of time and a master apparatus from which a probe response frame is received last during the period may be set as a connection partner. Alternatively, in the slave apparatus, for example, a notice or display indicating that there are a plurality of connectable master apparatuses may be performed, and the player may be caused to select a master apparatus to be connected.

In the embodiment described above, the example where both the master apparatus and the slave apparatus perform processes related to establishment of connection when shaking operations are performed thereon, has been exemplified. In addition to this, for example, on the slave apparatus, a shaking operation may not be performed. For example, on the master apparatus, a shaking operation may be performed as in the embodiment described above, but in the slave apparatus, a process for establishing connection, such as broadcasting the above probe request frame, may be performed when a button operation, a touch panel operation, or the like is performed.

On the contrary, on the master apparatus, a shaking operation may not be performed. For example, in the master apparatus, reception of the above probe request frame may be started when an operation of pressing a predetermined button, or the like is performed. In addition, at that time, reception of the probe request frame may be continued for a predetermined period of time after this operation or the like is performed, regardless of presence/absence of the button operation or the like. Alternatively, for example, reception of the probe request frame may be “started” when a predetermined button operation or the like is performed, and then the reception may be “stopped” when a predetermined button operation is performed (i.e., the player is caused to instruct timing at which the reception is stopped). Still alternatively, for example, reception of the probe request frame may be performed only while a button is pressed (the reception is stopped when the button pressing is stopped).

In a configuration where an shaking operation is performed on either the master apparatus or the slave apparatus, a list of connection candidates may be displayed on the apparatus on which a shaking operation is not performed. The master apparatus or slave apparatus on which a shaking operation is being performed may be highlighted in the list. For example, in the case of a configuration where a shaking operation is performed only on the master apparatus, the master apparatus is configured to broadcast information on the self-apparatus regardless of occurrence of “shaking” the self-apparatus. In the slave apparatus, this information is received, and a list of master apparatuses as connection candidates is generated and displayed on the screen. Then, when the master apparatus is shaken, information indicating that the self-apparatus is being shaken is incorporated into the broadcasted information on the self-apparatus. In the slave apparatus, this information is received, and an item of the master apparatus associated with the information is, for example, highlighted in the list of master apparatuses. Thus, it is easily and visually recognized that the master apparatus is inviting participants. Then, the player of the slave apparatus may select the highlighted master apparatus, and the above-described process for connection may be performed. This is useful, particularly, for the case where there are a plurality of master apparatuses. In addition, at that time, the above-describe process for connection may be performed only during the highlighting. In other words, when there is no candidate highlighted in the list of connection candidates, even if a certain master apparatus is selected and a button operation or the like is performed, connection may not be established, and only when any one candidate is highlighted, connection to the highlighted terminal may be established.

In the case of a configuration where a shaking operation is performed only on the slave apparatus, the master apparatus may display a list of slave apparatuses. For example, the slave apparatus is configured to broadcast information on the self-apparatus regardless of occurrence of “shaking” the self-apparatus. In the master apparatus, this information is received, and a list of slave apparatus candidates is generated on the basis of this information and displayed on the screen. In the slave apparatus, when the slave apparatus is shaken, information on the self-apparatus into which information indicating the shaking is incorporated is broadcasted. In the master apparatus, on the basis of this information, the slave apparatus associated with this information may be highlighted in the list and may be selected by a button operation or the like performed by the player, and a process for establishing connection may be performed. It is noted that regarding such list display, it is needless to say that such list display may be performed even in the case where both the master apparatus and the slave apparatus are shaken as in the embodiment described above.

In the embodiment described above, a series of processes for establishing wireless connection to another apparatus is performed in a single apparatus (the master apparatus or the slave apparatus) when the handheld game apparatus 10 is shaken. In another embodiment, the series of processes may be performed in an information processing system that includes a plurality of information processing apparatuses. For example, in an information processing system that includes a terminal side apparatus and a server side apparatus capable of communicating with the terminal side apparatus via a network, a part of the series of processes may be performed by the server side apparatus. Alternatively, in an information processing system that includes a terminal side apparatus and a server side apparatus capable of communicating with the terminal side apparatus via a network, a main process of the series of the processes may be performed by the server side apparatus, and a part of the series of the processes may be performed by the terminal side apparatus. Still alternatively, in the information processing system, a server side system may include a plurality of information processing apparatuses, and a process to be performed in the server side system may be divided and performed by the plurality of information processing apparatuses.

### (Appended Notes)

It is possible to extract the following configurations from the specific embodiments described above.

1. An information processing apparatus including a communicator capable of performing short-range wireless communication, the information processing apparatus comprising:
a motion detector configured to detect a motion applied to the information processing apparatus; and
a scanning process executor configured to perform a process of scanning another information processing apparatus when application of a predetermined motion to the information processing apparatus is detected by the motion detector.

2. A computer-readable non-transitory storage medium having stored therein an information processing program executed by a computer of an information processing apparatus including a communicator capable of performing short-range wireless communication, the information processing program causing the computer to operate as:
a motion detector configured to detect a motion applied to the information processing apparatus, by using a predetermined motion sensor; and
a scanning process section configured to execute a process of scanning another information processing apparatus when application of a predetermined motion to the information processing apparatus is detected by the motion detector.

3. An information processing method used in an information processing apparatus including a communicator capable of performing short-range wireless communication, the information processing method comprising the steps of:
detecting a motion applied to the information processing apparatus, by using a predetermined motion sensor; and
executing a process of scanning another information processing apparatus when application of a predetermined motion to the information processing apparatus is detected in the detecting step.

4. An information processing system including a communicator capable of performing short-range wireless communication, the information processing system comprising:
a motion detector configured to detect a motion applied to the information processing system; and
a scanning process executor configured to execute a process of scanning another information processing apparatus when application of a predetermined motion to the information processing system is detected by the motion detector.

5. An information processing apparatus including a communicator capable of performing short-range wireless communication, the information processing apparatus comprising:
a motion detector configured to detect a motion applied to the information processing apparatus; and
a response process section configured to execute a process of responding to a scanning process performed by another information processing apparatus when application of a predetermined motion to the information processing apparatus is detected by the motion detector.

6. A computer-readable non-transitory storage medium having stored therein an information processing program executed by a computer of an information processing apparatus including a communicator capable of performing short-range wireless communication, the information processing program causing the computer to operate as:
a motion detector configured to detect a motion applied to the information processing apparatus, by using a predetermined motion sensor; and
a response process section configured to execute a process of responding to a scanning process performed by another information processing apparatus when application of a predetermined motion to the information processing apparatus is detected by the motion detector.

7. An information processing method used in an information processing apparatus including a communicator capable of performing short-range wireless communication, the information processing method comprising the steps of:
detecting a motion applied to the information processing apparatus, by using a predetermined motion sensor; and
executing a process of responding to a scanning process performed by another information processing apparatus when application of a predetermined motion to the information processing apparatus is detected in the detecting step.

8. An information processing system including a communicator capable of performing short-range wireless communication, the information processing system comprising:
a motion detector configured to detect a motion applied to the information processing system; and
a response process section configured to execute a process of responding to a scanning process performed by another information processing apparatus when application of a predetermined motion to the information processing system is detected by the motion detector.

9. An information processing apparatus including a communicator capable of performing short-range wireless communication, the information processing apparatus comprising:
a motion detector configured to detect a motion applied to the information processing apparatus; and
a connection requester configured to execute a connection request process of requesting wireless connection to an unspecified number of or a plurality of other information processing apparatuses when application of a predetermined motion to the information processing apparatus is detected by the motion detector.

10. A computer-readable non-transitory storage medium having stored therein an information processing program executed by a computer of an information processing apparatus including a communicator capable of performing short-range wireless communication, the information processing program causing the computer to operate as:
a motion detector configured to detect a motion applied to the information processing apparatus, by using a predetermined motion sensor; and
a connection requester configured to execute a connection request process of requesting wireless connection to an unspecified number of or a plurality of other information processing apparatuses when application of a predetermined motion to the information processing apparatus is detected by the motion detector.

11. An information processing method used in an information processing apparatus including a communicator capable of performing short-range wireless communication, the information processing method comprising the steps of:
detecting a motion applied to the information processing apparatus, by using a predetermined motion sensor; and
executing a connection request process of requesting wireless connection to an unspecified number of or a plurality of other information processing apparatuses when application of a predetermined motion to the information processing apparatus is detected in the detecting step.

12. An information processing system including a communicator capable of performing short-range wireless communication, the information processing system comprising:
a motion detector configured to detect a motion applied to the information processing system; and
a connection requester configured to execute a connection request process of requesting wireless connection to an unspecified number of or a plurality of other information processing apparatuses when application of a predetermined motion to the information processing system is detected by the motion detector.

13. An information processing apparatus including a communicator capable of performing short-range wireless communication, the information processing apparatus comprising:
a motion detector configured to detect a motion applied to the information processing apparatus; and
a connection responder configured to execute a process of responding to a connection request from another information processing apparatus when application of a predetermined motion to the information processing apparatus is detected by the motion detector.

14. A computer-readable non-transitory storage medium having stored therein an information processing program executed by a computer of an information processing apparatus including a communicator capable of performing short-range wireless communication, the information processing program causing the computer to operate as:
a motion detector configured to detect a motion applied to the information processing apparatus, by using a predetermined motion sensor; and
a connection responder configured to execute a process of responding to a connection request from another information processing apparatus when application of a predetermined motion to the information processing apparatus is detected by the motion detector.

15. An information processing method used in an information processing apparatus including a communicator capable of performing short-range wireless communication, the information processing method comprising the steps of:
detecting a motion applied to the information processing apparatus, by using a predetermined motion sensor; and
executing a process of responding to a connection request from another information processing apparatus when application of a predetermined motion to the information processing apparatus is detected in the detecting step.

16. An information processing system including a communicator capable of performing short-range wireless communication, the information processing system comprising:
a motion detector configured to detect a motion applied to the information processing system; and
a connection responder configured to execute a process of responding to a connection request from another information processing apparatus when application of a predetermined motion to the information processing system is detected by the motion detector.

What is claimed is:

1. An information processing system in which a plurality of information processing apparatuses each including a communicator capable of performing short-range wireless communication directly perform transmission/reception of data with each other via the short-range wireless communication,
the information processing system comprising a first information processing apparatus and a second information processing apparatus,
the first information processing apparatus including:
a transmitter configured to transmit predetermined data to an unspecified number of or a plurality of the other information processing apparatuses by using the communicator; and
a first process executor configured to execute predetermined information processing,
the second information processing apparatus including:
a receiver capable of receiving the predetermined data transmitted from the transmitter, by using the communicator;
a motion detector configured to detect a motion applied to the second information processing apparatus;
a second process executor configured to execute predetermined information processing; and
a response process section configured to execute a response process to the predetermined data received from the first information processing apparatus when application of a predetermined motion to the second information processing apparatus is detected by the motion detector,
each of the first process executor and the second process executor executing the predetermined information processing with the other process executor after the response process is completed.

2. The information processing system according to claim 1, wherein
the first information processing apparatus further includes the motion detector, and
the transmitter transmits the predetermined data when application of the predetermined motion to the first information processing apparatus is detected by the motion detector of the first information processing apparatus.

3. The information processing system according to claim 1, wherein the predetermined information processing executed between the first process executor and the second process executor is a process for establishing connection of the short-range wireless communication.

4. The information processing system according to claim 1, wherein
the first information processing apparatus further includes the motion detector, and
in the information processing system, when the predetermined motion is being detected in both the first information processing apparatus and the second information processing apparatus, a process for establishing connection of the short-range wireless communication is executed between the first process executor and the second process executor.

5. The information processing system according to claim 4, wherein the motion detector detects, as the predetermined motion, a motion of a player shaking the information processing apparatus.

6. The information processing system according to claim 1, wherein if the predetermined motion is being detected when the receiver receives the predetermined data transmitted from the transmitter, the response process section executes the response process to the predetermined data.

7. The information processing system according to claim 1, further comprising a third information processing apparatus capable of executing the same function as that of the first information processing apparatus, wherein
the predetermined information processing is executed among the first information processing apparatus, the second information processing apparatus, and the third information processing apparatus.

8. The information processing system according to claim 1, further comprising a fourth information processing apparatus capable of executing the same function as that of the second information processing apparatus, wherein
the predetermined information processing is executed among the first information processing apparatus, the second information processing apparatus, and the fourth information processing apparatus.

9. The information processing system according to claim 1, wherein when application of the predetermined motion to the second information processing apparatus is detected by the motion detector, the response process section continues to execute the response process to the predetermined data for a predetermined period of time, regardless of presence/absence of later detection of the predetermined motion.

10. The information processing system according to claim 1, wherein when the predetermined motion applied to the second information processing apparatus meets a predetermined condition, the response process section repeatedly executes the response process to the predetermined data, regardless of presence/absence of later detection of the predetermined motion.

11. The information processing system according to claim 1, wherein
the first information processing apparatus further includes the motion detector,
the transmitter transmits data for scanning another information processing apparatus when application of the predetermined motion to the first information processing apparatus is detected by the motion detector of the first information processing apparatus, and
the response process section responds to the scanning when application of the predetermined motion is detected by the motion detector of the second information processing apparatus.

12. The information processing system according to claim 1, wherein
the first information processing apparatus further includes the motion detector,
the transmitter transmits, to another information processing apparatus, data representing a connection request when application of the predetermined motion to the first information processing apparatus is detected by the motion detector of the first information processing apparatus, and
the response process section responds to the connection request when application of the predetermined motion is detected by the motion detector of the second information processing apparatus.

13. The information processing system according to claim 1, further comprising a fifth information processing apparatus capable of executing the same function as that of the first information processing apparatus, wherein
the second information processing apparatus further includes a notifier configured to execute a process for prompting a player of the second information processing apparatus to make the predetermined motion,
the receiver continues a process of receiving the predetermined data even after predetermined processing is started between the first process executor and the second process executor,
the notifier executes the process for prompting to make the predetermined motion when the receiver receives the predetermined data from the fifth information processing apparatus after the predetermined processing is started between the first process executor and the second process executor, and
in the information processing system, when the predetermined motion is detected, the predetermined information processing is executed among the first information processing apparatus, the second information processing apparatus, and the fifth information processing apparatus.

14. A computer-readable non-transitory storage medium having stored therein an information processing program executed by a computer of each information processing apparatus of an information processing system which includes at least a first information processing apparatus and a second information processing apparatus each including a communicator capable of performing short-range wireless communication and in which transmission/reception of data is performed directly between the information processing apparatuses using the short-range wireless communication, the information processing program causing the computer to operate as:
a transmitter configured to transmit predetermined data from the first information processing apparatus to an unspecified number of or a plurality of the other information processing apparatuses by using the communicator;
a first process executor configured to execute predetermined information processing in the first information processing apparatus;
a receiver configured to receive the predetermined data transmitted from the transmitter, by using the communicator in the second information processing apparatus;
a motion detector configured to detect a motion applied to the second information processing apparatus, by using a predetermined motion sensor;
a second process executor configured to execute predetermined information processing in the second information processing apparatus; and
a response process section configured to execute a response process to the predetermined data received from the first information processing apparatus when application of a predetermined motion to the second information processing apparatus is detected,
each of the first process executor and the second process executor executing the predetermined information processing with the process executor in the other information processing apparatus after the response process is completed.

15. An information processing method for controlling an information processing system which includes at least a first information processing apparatus and a second information processing apparatus each including a communicator capable of performing short-range wireless communication and in which transmission/reception of data is performed directly between the information processing apparatuses using the short-range wireless communication, the information processing method comprising the steps of:
the first information processing apparatus transmitting predetermined data to an unspecified number of or a plurality of the other information processing apparatuses by using the communicator;
the first information processing apparatus executing predetermined information processing;
the second information processing apparatus receiving the predetermined data transmitted in the transmitting step, by using the communicator;
the second information processing apparatus detecting a motion applied to the second information processing apparatus itself, by using a predetermined motion sensor;
the second information processing apparatus executing predetermined information processing; and
executing a response process to the predetermined data received from the first information processing apparatus when application of a predetermined motion to the second information processing apparatus is detected,
in each of the executing step of the first information processing apparatus and the executing step of the second information processing apparatus, the predetermined information processing is executed with the other information processing apparatus after the response process is completed.
